(19) United States
(12) Patent Application Publication
(10) Pub. No.: US 2026/0217330 A1
(43) Pub. Date: Jul. 30, 2026

(54) A FRONT FORK ASSEMBLY FOR A SADDLE TYPE VEHICLE

(71) Applicant: TVS Motor Company Limited, Chennai (IN)

(72) Inventors: Muthuputhiavan Puthiavan, Chennai (IN); Barath Mohan, Chennai (IN); Velagapudi Sai Praveen, Chennai (IN)

(73) Assignee: TVS Motor Company Limited, Chennai (IN)

(21) Appl. No.: 19/145,759

(22) PCT Filed: Jan. 3, 2024
(86) PCT No.: PCT/IN2024/050006

§ 371 Date: Jul. 3, 2025

(30) Foreign Application Priority Data
Jan. 4, 2023 (IN) 202341000690

(51) Int. Cl. B62K 21/22; B62K 21/02; F16H 19/02

(52) U.S. Cl. CPC B62K 21/22; B62K 21/02; F16H 19/02

(57) ABSTRACT

A front fork assembly, for a saddle type vehicle, includes: a steering tube connected to a handlebar of the vehicle; a pair of front forks that support a front wheel of the vehicle; a first member that connects said steering tube to said pair of front forks, where said first member includes a predetermined recess and is configured to receive an upper inner member, and said upper inner member is operatively connected to said first member and is fixedly connected to the steering tube; a second member that connects said steering tube to said pair of front forks, where said second member includes a predetermined recess and is configured to receive a lower inner member, and said lower inner member is operatively connected to said second member and is connected to the steering tube; and a pair of upper and lower transmission assembly.

### FIELD OF THE INVENTION

The present invention generally relates to a vehicle. More particularly, the present invention relates to a front fork assembly of a vehicle.

### BACKGROUND OF THE INVENTION

Generally, in a vehicle, especially a saddle type vehicle, a pair of front forks connect the wheels, an upper bracket and a lower bracket through a head pipe for transferring steering motion provided on a handlebar to the wheels. Saddle type vehicles are increasingly used by consumers for more than one type of operation such as commuting, touring, racing and off roading. However, vehicle characteristics required for each of these operations slightly differ from each other. There are specifically three parameters that are critical for changing ride handling characteristics, namely, castor angle, trail and wheelbase. In existing saddle type vehicles, these three parameters are fixed and hence ride handling characteristics cannot be adjusted based on the type of operation by the user.

There is a direct correlation between the above three parameter and stability and manoeuvrability characteristics of the saddle type vehicle. A change in any of the above three parameters result in a change in the stability and manoeuvrability characteristics of the vehicle. An increase in the values in the above three geometry parameters generally improves stability but has a detrimental effect on manoeuvrability performance. Thus, there always remains a trade-off between stability and manoeuvrability performance with these geometry parameters. Conventional saddle type vehicles are generally designed for a unique requirement considering the segment it is targeted for, and the performance requirements in other riding conditions are compromised accordingly. However, by providing for adjustment of the castor angle, trail and wheelbase, both stability and manoeuvrability performance of a saddle type vehicle can be improved according to the requirement of the rider.

In previous attempts for provision of adjustment of trail, castor angle and wheelbase, provisions have been made for adjustment of steering offset and thus adjustment in trail, castor angle and wheelbase. However, in these saddle type vehicles, there remains a need to unfasten a plurality of screws for this adjustment. This makes the adjustment an arduous and tedious task. In other attempts, adjustment of steering offset has been provided for through eccentric inserts. However, the issue of unfastening screws still remains, which increases the time taken for this adjustment. This also means that the adjustment cannot be made in a vehicle running condition.

Thus, there is a need in the art for a front fork assembly for a saddle type vehicle, which addresses at least the aforementioned problems.

### SUMMARY OF THE INVENTION

In one aspect, the present invention is directed towards a front fork assembly for a saddle type vehicle. The front fork assembly has a steering tube and a pair of front forks. The front fork assembly has a first member for connecting the steering tube to the front forks and having a recess to receive an upper inner member that is operatively connected to the first member. The upper inner member is fixedly connected to the steering tube. A second member connects the steering tube to the front forks. The second member has a recess to receive a lower inner member operatively connected to the second member. The lower inner member is connected to the steering tube. A pair of upper and lower transmission assembly are operatively connected to the upper inner member and lower inner member.

In an embodiment of the invention, the upper inner member is slidably connected to said first member.

In a further embodiment of the invention, the lower inner member is slidably connected to said second member.

In a further embodiment of the invention, the first member and the second member are configured to have the predefined recess, wherein said upper inner member and lower inner member tend to slide based on an output command in a longitudinal direction of said front fork assembly.

In a further embodiment of the invention, the upper transmission assembly has a set of upper eccentric gears provided on the first member.

In a further embodiment of the invention, the lower transmission assembly has a set of lower eccentric gears provided on the second member.

In a further embodiment of the invention, the set of upper eccentric gears are connected to said set of lower eccentric gears through a joining shaft. Rotation of the set of upper eccentric gears or the set of lower eccentric gears causes the upper inner member to slide in the first member and the lower inner member to slide in the second member, thereby adjusting an offset between the steering tube and the pair of front forks.

In a further embodiment of the invention, the set of upper eccentric gears has an upper central gear connected to the first member through the joining shaft, and a pair of upper auxiliary gears. The pair of upper auxiliary gears are configured to mesh with the upper central gear and are operatively connected to the upper inner member through a pair of first auxiliary shafts. Herein, length of the pair of first auxiliary shafts is lower than a length of the joining shaft.

In a further embodiment of the invention, the upper central gear is provided in between the pair of upper auxiliary gears.

In a further embodiment of the invention, the first member has a first slot for accommodating the joining shaft extending from the upper central gear, for allowing only rotational movement of the joining shaft in the first member.

In a further embodiment of the invention, the upper inner member has a first longitudinal groove for accommodating the joining shaft extending from the upper central gear. Rotation of the upper central gear causes the pair of upper auxiliary gears to rotate, and rotation of the pair of upper auxiliary gears causes the upper inner member to slide in the first member.

In a further embodiment of the invention, the set of lower eccentric gears has a lower central gear connected to the second member through the joining shaft, and a pair of lower auxiliary gears configured to mesh with the lower central gear. The lower auxiliary gears are operatively connected to the lower inner member through a pair of second auxiliary shafts, wherein a length of the pair of second auxiliary shafts is lower than the length of the joining shaft.

In a further embodiment of the invention, the lower central gear is provided between the pair of lower auxiliary gears.

In a further embodiment of the invention, the second member has a second slot for accommodating the joining shaft extending to the lower central gear, for allowing only rotational movement of the joining shaft with respect to the second member.

In a further embodiment of the invention, the lower inner member has a second longitudinal groove for accommodating the joining shaft extending to the lower central gear. Rotation of the lower central gear causes the pair of lower auxiliary gears to rotate, and rotation of the pair of lower auxiliary gears causes the lower inner member to slide in the second member.

In another aspect, the present invention is directed towards multi wheeled vehicle having a front fork assembly. The front fork assembly has a steering tube and a pair of front forks. The front fork assembly has a first member for connecting the steering tube to the front forks and having a recess to receive an upper inner member that is operatively connected to the first member. The upper inner member is fixedly connected to the steering tube. A second member connects the steering tube to the front forks. The second member has a recess to receive a lower inner member operatively connected to the second member. The lower inner member is connected to the steering tube. A pair of upper and lower transmission assembly are operatively connected to the upper inner member and lower inner member.

### BRIEF DESCRIPTION OF THE DRAWINGS

Reference will be made to embodiments of the invention, examples of which may be illustrated in accompanying figures. These figures are intended to be illustrative, not limiting. Although the invention is generally described in context of these embodiments, it should be understood that it is not intended to limit the scope of the invention to these particular embodiments.

FIG. 1 illustrates side view of an exemplary a saddle type vehicle, in accordance with an embodiment of the present invention.

FIG. 2 illustrates a right side view of the saddle type vehicle, in accordance with an embodiment of the present invention.

FIG. 3 illustrates a top perspective view of a front fork assembly for the saddle type vehicle, in accordance with an embodiment of the present invention.

FIG. 4 illustrates a front view of the front fork assembly, in accordance with an embodiment of the present invention.

FIG. 5 illustrates an exploded view of the front fork assembly, in accordance with an embodiment of the present invention.

FIG. 6 illustrates an exploded view of a first member and an upper inner member of the front fork assembly, in accordance with an embodiment of the present invention.

FIG. 7 illustrates a bottom view of the first member and the upper inner member of the front fork assembly, in accordance with an embodiment of the present invention.

FIG. 8 illustrates a sectional view of the front for assembly along section A-A illustrated in FIG. 7, in accordance with an embodiment of the present invention.

FIG. 9 illustrates a top view of an upper transmission assembly of the front fork assembly in different positions, in accordance with an embodiment of the present invention.

FIG. 10 illustrates a bottom perspective view of the front fork assembly, in accordance with an embodiment of the present invention.

FIG. 11 illustrates a top view of a second member and a lower inner member of the front fork assembly, in accordance with an embodiment of the present invention.

FIG. 12 illustrates a sectional view of the front fork assembly along section B-B illustrated in FIG. 11, in accordance with an embodiment of the present invention.

### DETAILED DESCRIPTION OF THE INVENTION

The present invention generally relates to a saddle type vehicle. More particularly, the present invention relates to a front fork assembly for the saddle type vehicle.

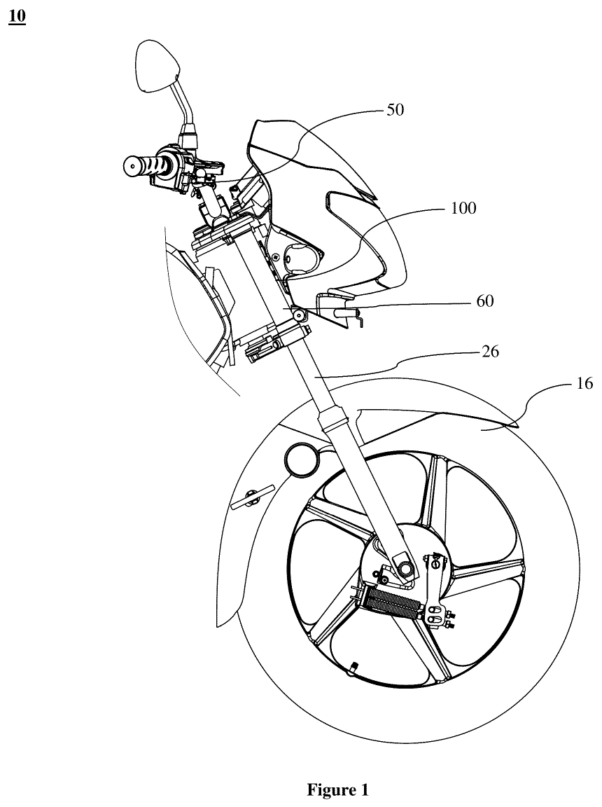

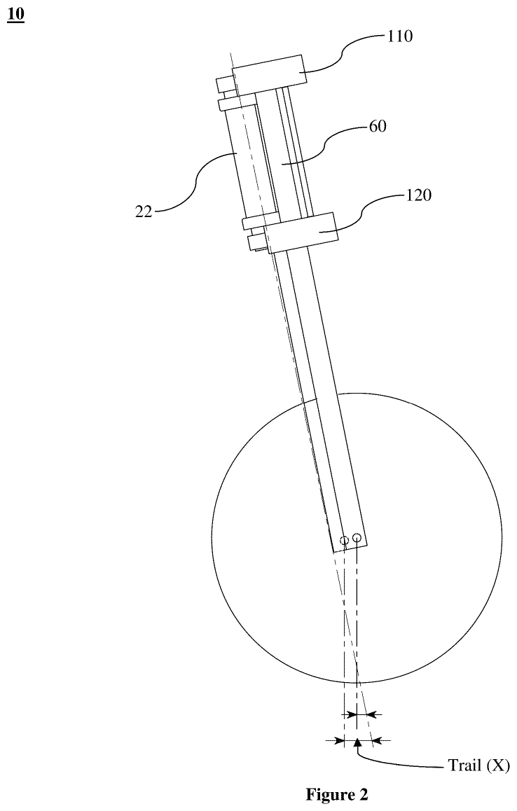

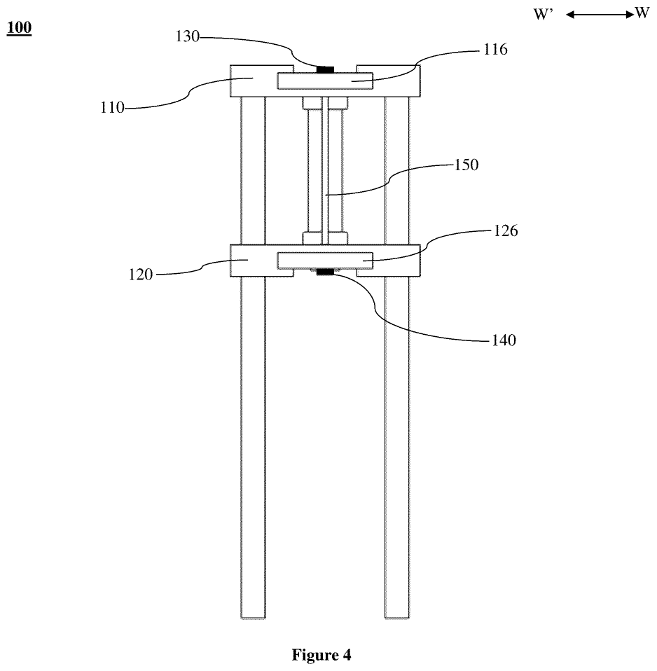

FIG. 1 illustrates an exemplary saddle type vehicle 10, in accordance with an embodiment of the invention. The vehicle 10 further has a head tube (not shown) that supports a steering tube 22 (shown in FIG. 2). The steering tube 22 is connected to a handlebar 50 of the vehicle 10. The vehicle 10 further comprises a pair of front forks 60 The pair of front forks 60 are configured to support the front wheel 16 of the vehicle 10. In an embodiment, the pair of front forks 60 support a front wheel 16 through two telescopic front suspension 26. The vehicle 10 further includes the handlebar 50 connected to the steering tube 22 and extending in a vehicle width direction (W-W′) (shown in FIG. 4). The handlebar 50 can rotate to both sides of the vehicle 10 during vehicle turning movements.

As referred to in FIG. 2, mechanical trail is defined as the perpendicular distance between the steering axis, i.e. axis of the steering tube 22 and the point of contact between the front wheel 16 and the ground. The mechanical trail is depicted as (X) in the FIG. 2. Adjustment of the mechanical trail (X) can be achieved by adjusting the offset between the steering axis with respect to the pair of front forks 60, i.e. the offset between the steering tube 22 and the pair of front forks 60. The ride characteristics such as stability and manoeuvrability can thus be adjusted. The present invention provides for a front fork assembly 100 in which offset between the steering tube 22 and the pair of front forks 60 can be achieved.

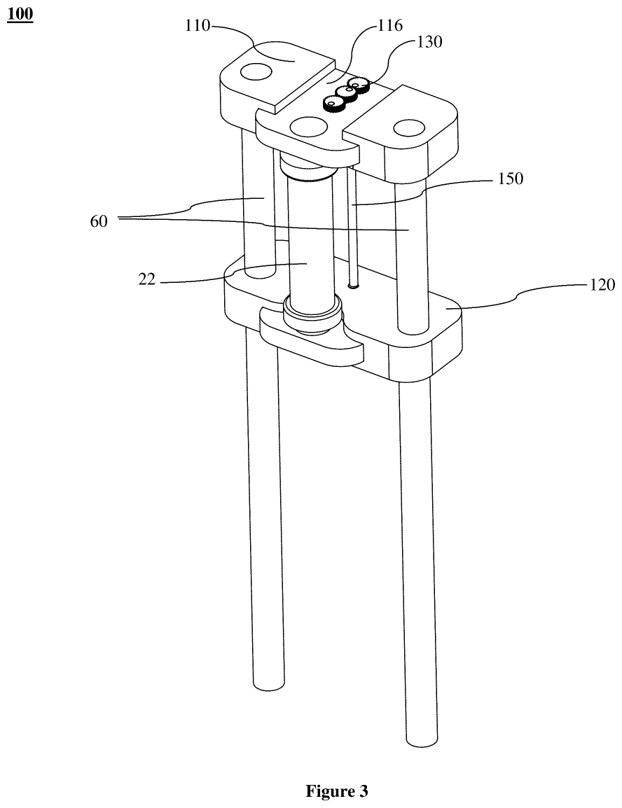

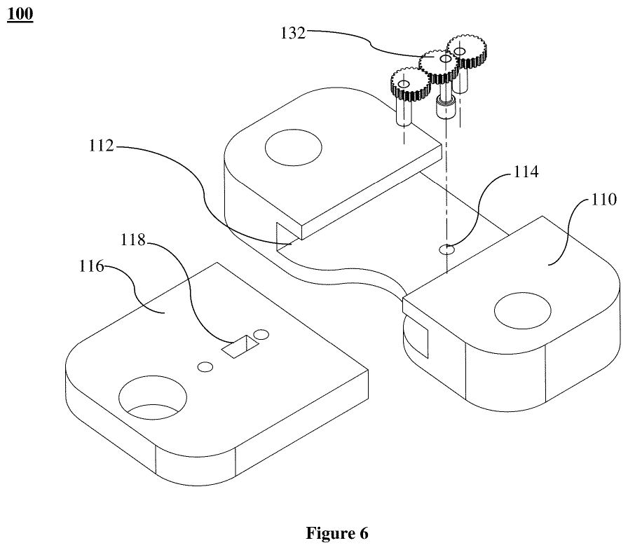

In that, as illustrated in FIG. 3 and FIG. 4, the front fork assembly 100 comprises a first member 110. The first member 110 is configured for connecting the steering tube 22 to the pair of front forks 60. Herein, the first member 110 has a predetermined recess 112 (shown in FIG. 6). The first member 110 is configured to receive an upper inner member 116 in the predetermined recess 112. Further, the upper inner member 116 is operatively connected to the first member 110. Further, the upper inner member 116 is fixedly connected to the steering tube 22. Thus, a split construction of first member 110 and the upper inner member 116 is provided to connect the steering tube 22 to the pair of front forks 60, as opposed to a conventional single upper bracket.

As further illustrated in FIG. 3 and FIG. 4, the front fork assembly 100 comprises a second member 120. The second member 120 is configured for connecting the steering tube 22 to the pair of front forks 60, wherein the second member 120 is provided below the first member 110. Similar to the first member 110, the second member 120 has a predetermined recess (not shown). The second member 120 is configured to receive a lower inner member 126 in the predetermined recess. The lower inner member 126 is operatively connected to the second member 120. Further, the lower inner member 126 is connected to the steering tube 22. Thus, a split construction of second member 120 and the lower inner member 126 is provided to connect the steering tube 22 to the pair of front forks 60, as opposed to a conventional single lower bracket.

The front fork assembly 100 further comprises a pair of upper and lower transmission assembly 130,140. The pair of upper and lower transmission assembly 130, 140 are operatively connected to said upper inner member 116 and lower inner member 126 respectively. Movement of the pair of upper and lower transmission assembly 130, 140 is thus capable of causing the movement of the upper inner member 116 and the lower inner member 126, thus adjusting the offset between the steering tube 22 and the pair of front forks 60, thus adjusting the trail (X).

In an embodiment, the upper inner member 116 is slidably connected to the first member 110 and the lower inner member 126 is slidably connected to the second member 120. Herein, the first member 110 and the second member 120 are configured to have the predefined recesses 112 as explained above. In that, the upper inner member 116 and the lower inner member 126 tend to slide in the predefined recesses 112 of the first member 110 and the second member 120 based on an output command. The upper inner member 116 and the lower inner member 126 tend to slide in a longitudinal direction of said front fork assembly 100, thereby adjusting the offset between the steering tube 22 and the pair of front forks 60.

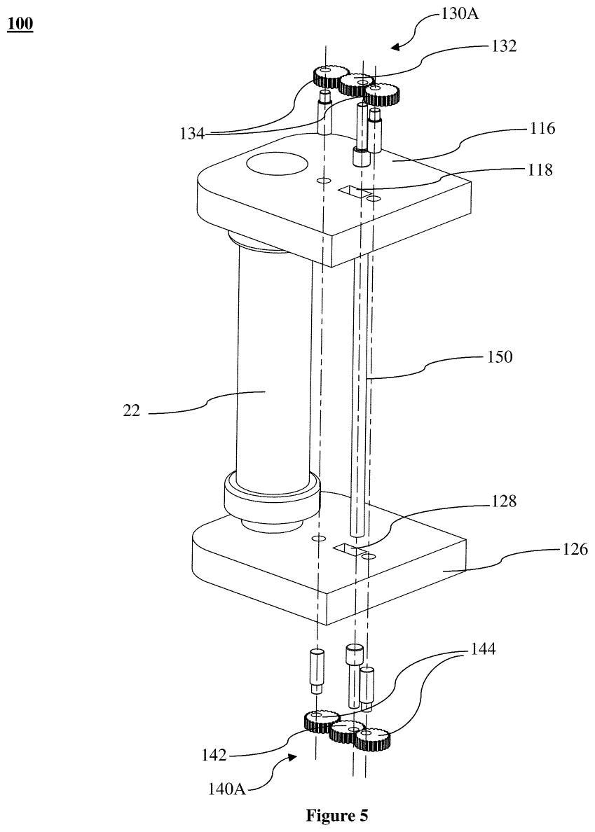

As illustrated in FIG. 5, for causing the movement of the upper inner member 116 and the lower inner member 126 for adjusting the offset between the steering tube 22 and the pair of front forks 60, the upper transmission assembly 130 comprises a set of upper eccentric gears 130A provided on the first member 110. Similarly, the lower transmission assembly 140 comprises a set of lower eccentric gears 140A provided on the second member 120.

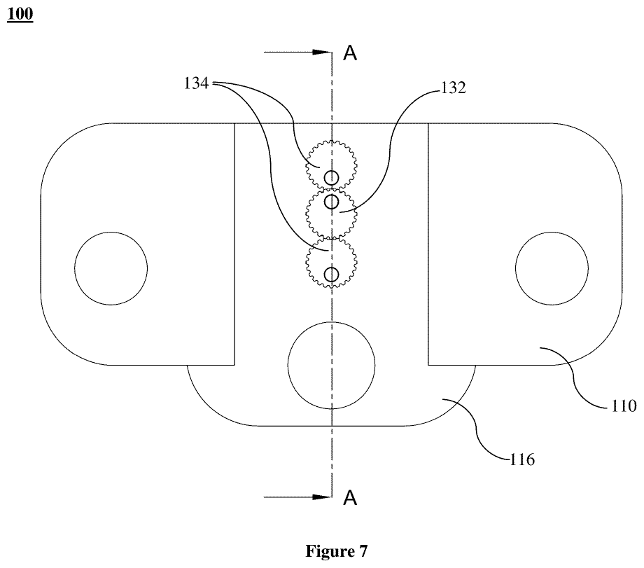

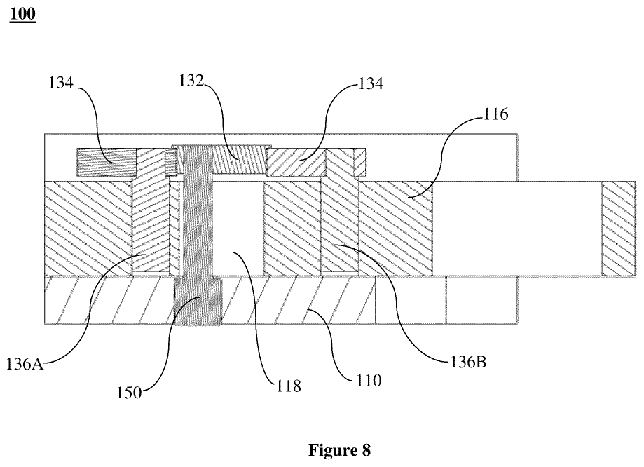

As illustrated in FIG. 5, and further referenced in FIG. 6, FIG. 7 and FIG. 8, the set of upper eccentric gears 130A are connected to the set of lower eccentric gears 140A through a joining shaft 150. Provision of the joining shaft 150 ensures that the set of lower eccentric gears 140A follow the movement of the set of upper eccentric gears 130A, or vice versa. This ensures that the movement of the upper inner member 116 is always equal to the movement of the lower inner member 126, thus preventing any misalignment.

Herein, rotation of the set of upper eccentric gears 130A or the set of lower eccentric gears 140A causes the upper inner member 116 to slide in the first member 110 and the lower inner member 126 to slide in the second member 120, thereby adjusting the offset between said steering tube 22 and the pair of front forks 60.

As further illustrated specifically in FIG. 7 and FIG. 8, the set of upper eccentric gears 130A has an upper central gear 132 that connected to the first member 110 through the joining shaft 150. Further, the set of upper eccentric gears 130A has a pair of upper auxiliary gears 134 configured to mesh with the upper central gear 132. Herein, the upper auxiliary gears 134 are operatively connected to the upper inner member 116 through a pair of first auxiliary shafts 136A, 136B. In that, since the pair of first auxiliary shafts 136A, 136B join the upper auxiliary gears 134 to the upper inner member 116, a length of the pair of first auxiliary shafts 136A, 136B is lower than a length of the joining shaft 150. As can be seen in FIG. 7 and FIG. 8, in an embodiment, the upper central gear 132 is provided in between the pair of upper auxiliary gears 134.

To accommodate this arrangement, the first member 110 has a first slot 114 for accommodating the joining shaft 150 extending from the upper central gear 132. Provision of the first slot 114 thus ensures that only rotational movement of the joining shaft 150 is allowed with respect to the first member 110. Further, the upper inner member 116 has a first longitudinal groove 118 for accommodating the joining shaft 150 extending from the upper central gear 132.

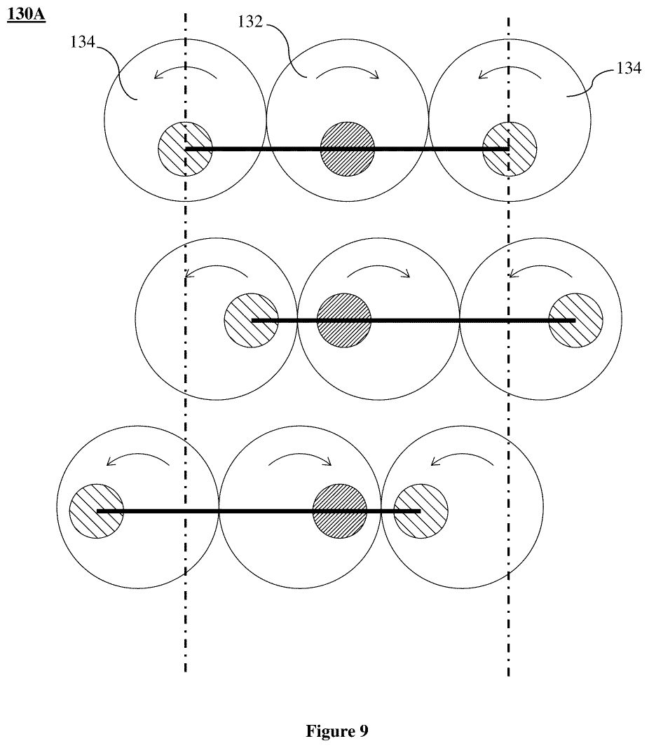

As specifically illustrated in FIG. 9, rotation of the upper central gear 132 causes the pair of upper auxiliary gears 134 to rotate. As illustrated in FIG. 9, since upper central gear 132 and the upper auxiliary gears 134 of the set of upper eccentric gears 130A have an eccentric configuration, rotation of the upper central gear 132 causes longitudinal movement of the upper auxiliary gears 134. Due to provision of the first slot 114, although the position of the joining shaft 150 remains fixed in the first member 110, longitudinal movement is caused in the upper auxiliary gears 134. The longitudinal motion of the upper auxiliary gears 134 is transmitted to the upper inner member 116 via the pair of first auxiliary shafts 136A, 136B. Thus, rotation of the pair of upper auxiliary gears 134 causes the upper inner member 116 to slide in the first member 110. Provision of the first longitudinal groove 118 ensures that movement of the upper inner member 116 with respect to the joining shaft 150 is free and not hindered in any manner. Thus, the offset between the steering tube 22 and the pair of front forks 60 is adjusted.

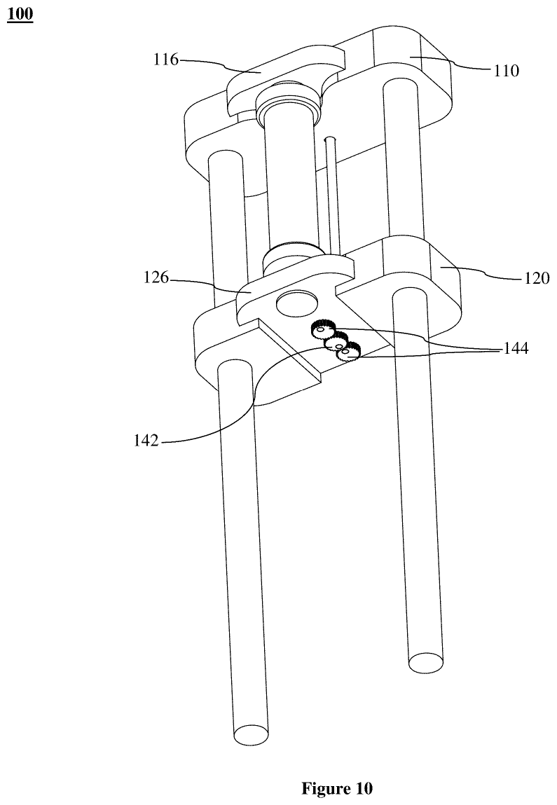

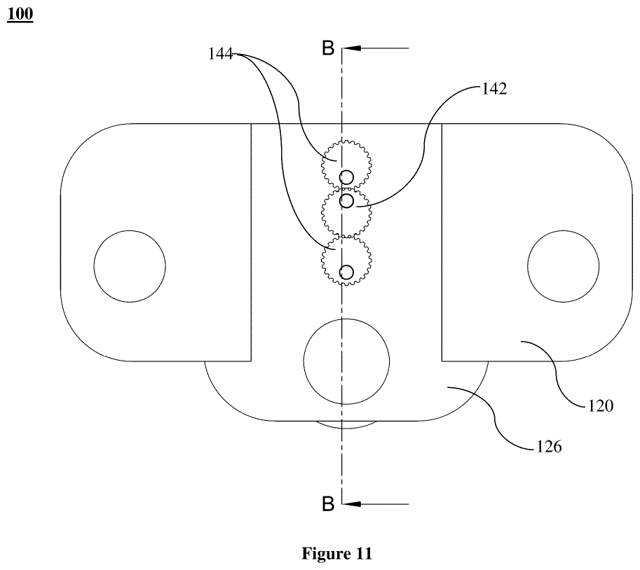

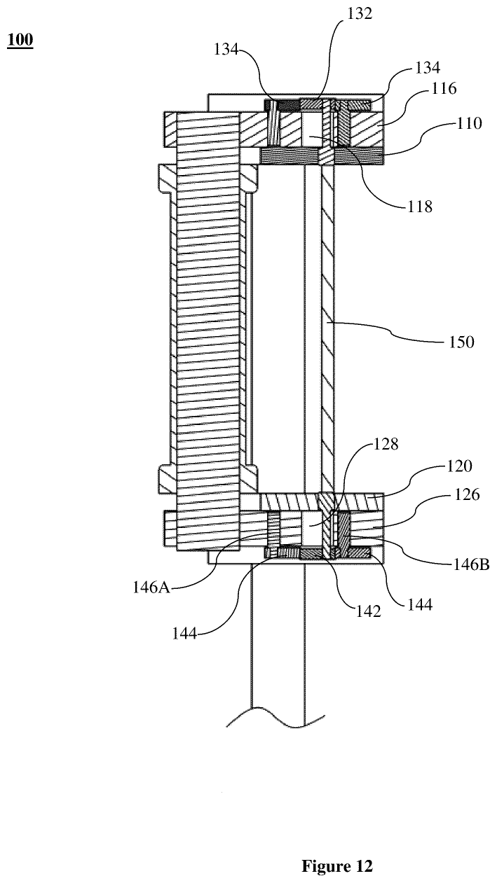

As illustrated in FIG. 10, FIG. 11 and FIG. 12, the set of lower eccentric gears 140A comprises a lower central gear 142. The lower central gear 142 is connected to the second member 120 through the joining shaft 150. The set of lower eccentric gears 140A further comprises a pair of lower auxiliary gears 154 that are configured to mesh with the lower central gear 152. The lower auxiliary gears 154 are operatively connected to the lower inner member 126 through a pair of second auxiliary shafts 146A, 146B. Accordingly, a length of the pair of first auxiliary shafts 146A, 146B is lower than the length of the joining shaft 150. In an embodiment, the lower central gear 142 is provided between the pair of lower auxiliary gears 144.

Similar to the first slot 114 as explained hereinbefore, the second member 120 comprises a second slot (not shown) for accommodating the joining shaft 150 extending to the lower central gear 142. Provision of the second slot thus ensures that only rotational movement of the joining shaft 150 is allowed with respect to the second member 120. Further, similar to the first longitudinal groove 118, the lower inner member 126 has a second longitudinal groove 128 for accommodating the joining shaft 150 extending to the lower central gear 142. As explained hereinbefore, rotation of the lower central gear 142 causes the pair of lower auxiliary gears 144 to rotate, and rotation of the pair of lower auxiliary gears 144 causes the lower inner member 126 to slide in the second member 120. Since the upper central gear 132 and the lower central gear 142 are connected by the joining shaft 150, movement of the upper central gear 132 is reflected in the movement of the lower central gear 142 and vice versa. Thus, in operation, either of the upper central gear 132 or the lower central gear 142 can be rotated by a user for adjusting the offset between the steering tube 22 and the pair of front forks 60. In an embodiment, in operation, either the upper central gear 132 or the lower central gear 142 can be electrically actuated through an electric motor, wherein the electric motor rotates according to a user command for adjusting the offset between the steering tube 22 and the pair of front forks 60 as explained above.

Although the present invention has been described in the context of the saddle type vehicle 10, it should be understood that the front fork assembly 100 as described may be applied to a three wheeled vehicle or a multi wheeled vehicle using a front fork assembly.

Advantageously, the present invention provides a front fork assembly in which offset between the steering tube and the pair of front forks can be adjusted with ease and in a cost-effective manner. The present invention provides for a front fork assembly in which the requirement of unfastening of screws for adjustment of offset is eliminated.

Easier adjustment of the offset of the steering tube and the pair of front forks means that characteristics like trail can be adjusted easily. Thus, the rider characteristics such as stability and manoeuvrability can be seamlessly adjusted according to the operation such as commuting, cruising, off-roading etc. This ensures that a single type vehicle can be used for commuting, cruising, off-roading etc. without making any system level modifications.

While the present invention has been described with respect to certain embodiments, it will be apparent to those skilled in the art that various changes and modification may be made without departing from the scope of the invention as defined in the following claims.

### LIST OF REFERENCE NUMERALS

10: Saddle Type Vehicle
16. Front Wheel
22: Steering Tube
50: Handlebar
60: Pair of Front Forks
26: Telescopic Front Suspensions
100: Front Fork Assembly
110: First Member
112: Recess of the First Member
114: First Slot
116: Upper Inner Member
118: First Longitudinal Groove
120: Second Member
126: Lower Inner Member
128: Second Longitudinal Groove
130: Upper Transmission Assembly
130A: Set of Upper Eccentric Gears
132: Upper Central Gear
134: Pair of Upper Auxiliary Gears
136A, 136B: Pair of First Auxiliary Shafts
140: Lower Transmission Assembly
140A: Set of Lower Eccentric Gears
142: Lower Central Gear
144: Pair of Lower Auxiliary Gears
146A, 146B: Pair of Second Auxiliary Shafts
150: Joining Shaft

1.-16. (canceled)

17. A front fork assembly for a saddle type vehicle, said front fork assembly comprising:
a steering tube connected to a handlebar of the vehicle;
a pair of front forks that support a front wheel of the vehicle;
a first member that connects said steering tube to said pair of front forks, where
said first member includes a predetermined recess and is configured to receive an upper inner member, and
said upper inner member is operatively connected to said first member and is fixedly connected to the steering tube;
a second member that connects said steering tube to said pair of front forks, where
said second member includes a predetermined recess and is configured to receive a lower inner member, and
said lower inner member is operatively connected to said second member and is connected to the steering tube; and
a pair of upper and lower transmission assembly that are operatively connected to said upper inner member and lower inner member.

18. The front fork assembly for the vehicle as claimed in claim 17,
wherein said upper inner member is slidably connected to said first member, and
wherein said lower inner member is slidably connected to said second member.

19. The front fork assembly for the vehicle as claimed in claim 17,
wherein said first member and second member being configured to have the predefined recess, and
wherein said upper inner member and lower inner member tend to slide based on an output command in a longitudinal direction of said front fork assembly.

20. The front fork assembly for the vehicle as claimed in claim 17,
wherein said upper transmission assembly comprises a set of upper eccentric gears provided on said first member, and
wherein said lower transmission assembly comprises a set of lower eccentric gears provided on said second member.

21. The front fork assembly for the vehicle as claimed in claim 20,
wherein said set of upper eccentric gears being connected to said set of lower eccentric gears through a joining shaft, and
wherein rotation of the set of upper eccentric gears or the set of lower eccentric gears causes the upper inner member to slide in the first member and the lower inner member to slide in the second member, thereby adjusting an offset between said steering tube and the pair of front forks.

22. The front fork assembly for the vehicle as claimed in claim 21,
wherein the set of upper eccentric gears comprises
an upper central gear connected to the first member through the joining shaft, and
a pair of upper auxiliary gears configured to mesh with the upper central gear, the upper auxiliary gears being operatively connected to the upper inner member through a pair of first auxiliary shafts, and
wherein a length of the pair of first auxiliary shafts is lower than a length of the joining shaft.

23. The front fork assembly for the vehicle as claimed in claim 22,
wherein the upper central gear is provided in between the pair of upper auxiliary gears.

24. The front fork assembly for the vehicle as claimed in claim 22,
wherein the first member comprises a first slot that accommodates the joining shaft extending from the upper central gear, that allows only rotational movement of the joining shaft with respect to the first member.

25. The front fork assembly for the vehicle as claimed in claim 24,
wherein the upper inner member comprises a first longitudinal groove that accommodates the joining shaft extending from the upper central gear, and
wherein rotation of the upper central gear causes the pair of upper auxiliary gears to rotate, and rotation of the pair of upper auxiliary gears causes the upper inner member to slide in the first member.

26. The front fork assembly for the vehicle as claimed in claim 21,
wherein the set of lower eccentric gears comprises
a lower central gear connected to the second member through the joining shaft, and
a pair of lower auxiliary gears configured to mesh with the lower central gear,
wherein the pair of lower auxiliary gears being operatively connected to the lower inner member through a pair of second auxiliary shafts, and
wherein a length of the pair of second auxiliary shafts is lower than the length of the joining shaft.

27. The front fork assembly for the vehicle as claimed in claim 26,
wherein the lower central gear is provided between the pair of lower auxiliary gears.

28. The front fork assembly for the vehicle as claimed in claim 26,
wherein the second member comprises a second slot that accommodates the joining shaft extending to the lower central gear, that allows only rotational movement of the joining shaft with respect to the second member.

29. The front fork assembly for the vehicle as claimed in claim 28,
wherein the lower inner member comprises a second longitudinal groove that accommodates the joining shaft extending to the lower central gear, and
wherein rotation of the lower central gear causes the pair of lower auxiliary gears to rotate, and rotation of the pair of lower auxiliary gears causes the lower inner member to slide in the second member.

30. A multi wheeled vehicle, comprising:
a front fork assembly comprising:
a steering tube connected to a handlebar of the vehicle;
a pair of front forks that support a front wheel of the vehicle;
a first member that connects said steering tube to said pair of front forks, where
said first member includes a predetermined recess and is configured to receive an upper inner member, and
said upper inner member is operatively connected to said first member and is fixedly connected to the steering tube;
a second member that connects said steering tube to said pair of front forks, where
said second member includes a predetermined recess and is configured to receive a lower inner member, and
said lower inner member is operatively connected to said second member and is connected to the steering tube; and
a pair of upper and lower transmission assembly that are operatively connected to said upper inner member and lower inner member.
